(19) United States
(12) Patent Application Publication
(10) Pub. No.: US 2022/0081268 A1
(43) Pub. Date: Mar. 17, 2022

(54) Tractor Trailer Jacking Assembly

(71) Applicant: Paul R. Davis, Nashville, TN (US)

(72) Inventor: Paul R. Davis, Nashville, TN (US)

(21) Appl. No.: 17/022,478

(22) Filed: Sep. 16, 2020

(51) Int. Cl. B66F 3/46; B66F 3/24; B60S 9/12

(52) U.S. Cl. CPC B66F 3/46; B60R 16/027; B60S 9/12; B66F 3/24

(57) ABSTRACT

A tractor trailer jacking assembly f includes a plurality of jacks that is each mounted on a bottom of a tractor trailer. Each of the jacks is positionable in an extended position to engage the ground to inhibit the tractor trailer from tipping. A control circuit is mounted on a semi tractor and the control circuit detects the speed of the semi tractor. A gyroscope unit is mounted on the semi tractor to detect a degree and a direction to which the semi tractor is tipping. The control circuit actuates the respective jacks into the deployed position on a corresponding side of the tractor trailer when the gyroscope unit detects the semi tractor has tipped beyond a pre-determined angle of tilt.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to trailer jacking devices and more particularly pertains to a new trailer jacking device for inhibiting a tractor trailer from tipping over while being towed.

### (2) Description of Related Art Including Information Disclosed Under 37 CFR 1.97 and 1.98

The prior art relates to trailer jacking devices. The prior art discloses a vehicle stabilizer device that includes a pair of arms, each having a wheel rotatably coupled thereto, for extending outwardly from a side of a vehicle to inhibit the vehicle from tipping. The prior art also discloses a vehicle stabilizer that is mounted to the rear of a tractor trailer and that is movable laterally away from the tractor trailer in the event of tipping to inhibit the tractor trailer from tipping over. The prior art discloses a variety of vehicle stabilizers that include a support that is extendable laterally from a vehicle during a tipping event to inhibit the vehicle from tipping over.

### BRIEF SUMMARY OF THE INVENTION

An embodiment of the disclosure meets the needs presented above by generally comprising a plurality of jacks that is each mounted on a bottom of a tractor trailer. Each of the jacks is positionable in an extended position to engage the ground to inhibit the tractor trailer from tipping. A control circuit is mounted on a semi tractor and the control circuit detects the speed of the semi tractor. A gyroscope unit is mounted on the semi tractor to detect a degree and a direction to which the semi tractor is tipping. The control circuit actuates the respective jacks into the deployed position on a corresponding side of the tractor trailer when the gyroscope unit detects the semi tractor has tipped beyond a pre-determined angle of tilt.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a right side view of a tractor trailer jacking assembly according to an embodiment of the disclosure.

FIG. 2 is a back view of an embodiment of the disclosure.

FIG. 3 is a back in-use view of an embodiment of the disclosure showing a jack being actuated into an extended position.

FIG. 4 is a schematic view of an embodiment of the disclosure.

### DETAILED DESCRIPTION OF THE INVENTION

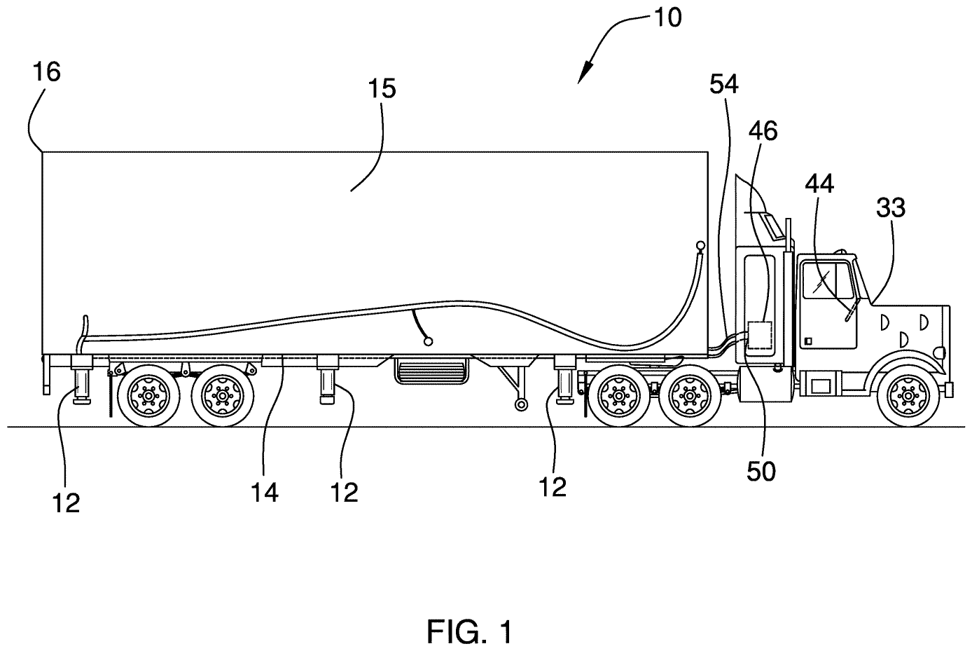

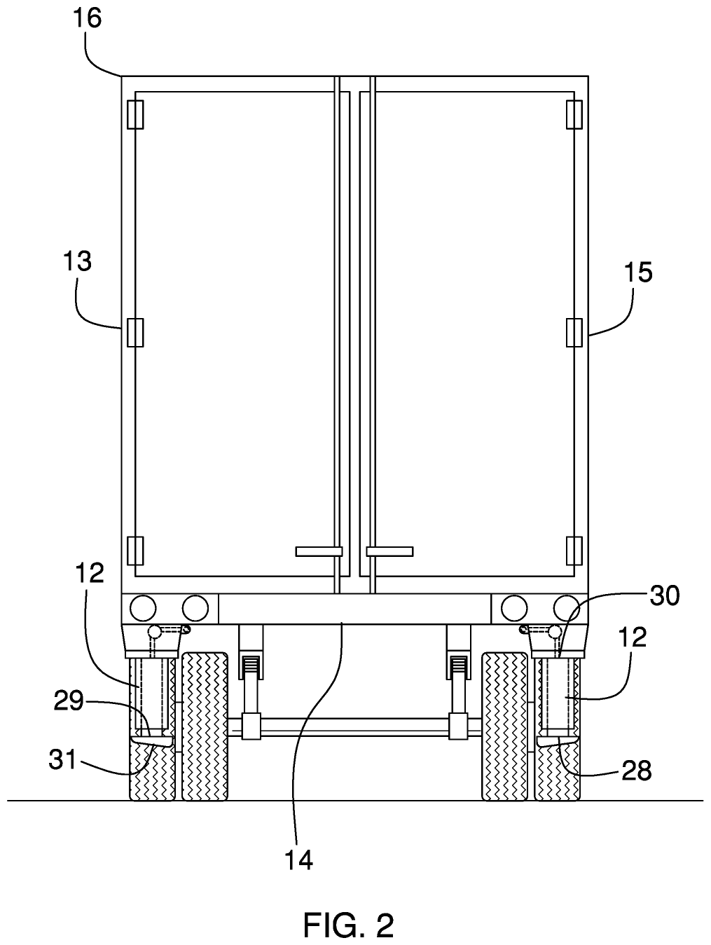

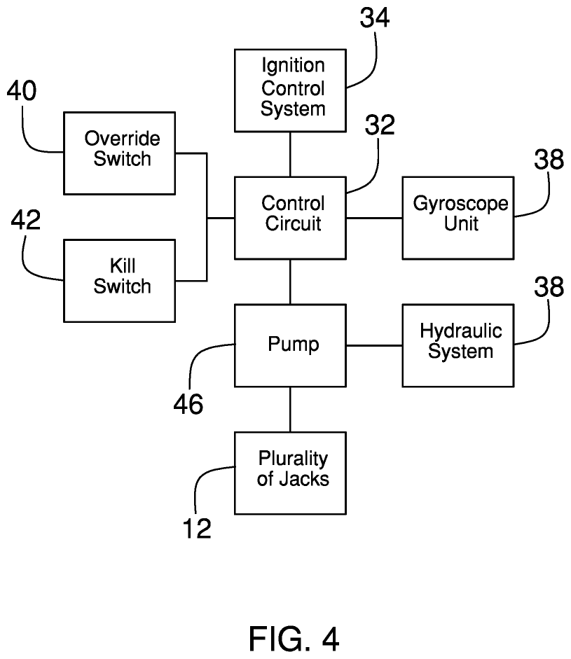

With reference now to the drawings, and in particular to FIGS. 1 through 4 thereof, a new trailer jacking device embodying the principles and concepts of an embodiment of the disclosure and generally designated by the reference numeral 10 will be described.

As best illustrated in FIGS. 1 through 4, the tractor trailer jacking assembly 10 generally comprises a plurality of jacks 12 that is each mounted on a bottom 14 of a tractor trailer 16. The plurality of jacks 12 is distributed along a respective left side 13 and right side 15 of the tractor trailer 16. Each of the jacks 12 is positionable in an extended position to engage the ground 18. In this way the jacks 12 inhibit the tractor trailer 16 from tipping. Moreover, each of the jacks 12 is positionable in a retracted position to facilitate the tractor trailer 16 to be towed normally. The tractor trailer 16 may be a livestock trailer, a refrigerated trailer or any other type of tractor trailer that is employed in over-the-road shipping.

The plurality of jacks 12 includes a set of left jacks 20 and a set of right jacks 22. Each of the left jacks 20 is positioned on the left side 13 of the tractor trailer 16 and each of the right jacks 22 is positioned on the right side 15 of the tractor trailer 16. Each of the jacks 12 includes a cylinder 24 and a piston 26 that is slidably positioned in the cylinder 24. The piston 26 has a distal end 28 with respect to the bottom of the tractor trailer 16 and the distal end 28 engages the ground 18 when the jacks 12 are in the extended position.

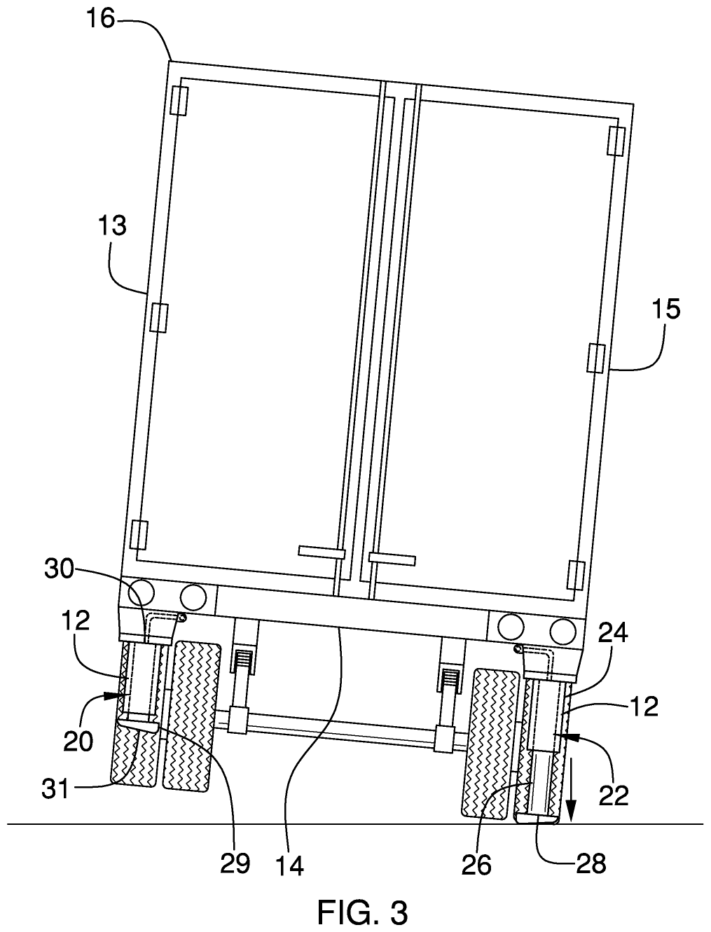

The distal end 28 is spaced from the ground 18 when the jacks 12 are in the retracted position and the cylinder 24 has an input port 30 thereon. Each of the jacks 12 may comprise hydraulic jacks or the like. Each of the jacks 12 includes a foot 29 that is mounted to the distal end 28 of the piston 26. The foot 29 has a bottom surface 31 and the bottom surface 31 slopes downwardly between an outer wall of the tractor trailer 16 and a middle of the tractor trailer 16. As is most clearly shown in FIG. 3, the bottom surface 31 of the foot 29 will rest flat on the ground 18 when the tractor trailer 16 begins to tip.

A control circuit 32 is mounted on a semi tractor 33 and the control circuit 32 is in electrical communication with an ignition control system 34 of the semi tractor 33. In this way the control circuit 32 can detect the speed of the semi tractor 33. The control circuit 32 is in electrical communication with each of the jacks 12. The control circuit 32 actuates the jacks 12 into the deployed position when the control circuit 32 detects the speed of the semi tractor 33 has exceeded a pre-determined trigger speed. In this way each of the jacks 12 can slow the semi tractor 33 through friction with the ground 18.

A gyroscope unit 38 is mounted on the semi tractor 33 to detect a degree and a direction to which the semi tractor 33 is tipping and the gyroscope unit 38 is in electrical communication with the control circuit 32. The control circuit 32 actuates the respective jacks 12 into the deployed position on a corresponding side of the tractor trailer 16 when the gyroscope unit 38 detects the semi tractor 33 has tipped beyond a pre-determined angle of tilt. In this way the jacks 12 inhibit the semi tractor 33 and tractor trailer 16 from tipping over, such as when the semi tractor 33 enters a turn at an excessive speed. Each of the left jacks 20 is actuated when the gyroscope unit 38 detects that the semi tractor 33 is tipping to the left. Moreover, each of the right jacks 22 is actuated when the gyroscope unit 38 detects that the semi tractor 33 is tipping to the right. The gyroscope unit 38 may include an electro-mechanical gyroscope, an electronic tilt detector that includes mercury switches or any other type of gyroscope unit that can effectively measure the tilt of the tractor trailer 16. Additionally, the gyroscope unit 38 may comprise a computer that calculates the likelihood of a tip-over condition based on the speed of the vehicle and steering orientation of the vehicle.

An override switch 40 is positioned within the semi tractor 33 to be accessible to the driver and the override switch 40 is electrically coupled to the control circuit 32. The override switch 40 inhibits the control circuit 32 from actuating the jacks 12 in either the extended position or the retracted position when the override switch 40 is engaged. In this way the driver can retain full command of the semi tractor 33 and the tractor trailer 16. A kill switch 42 is attached to a steering wheel 44 in the semi tractor 33 and the kill switch 42 is engaged when the driver grips the steering wheel 44. The kill switch 42 is electrically coupled to the control circuit 32. Moreover, the control circuit 32 actuates each of the jacks 12 into the deployed position when the kill switch 42 is disengaged. In this way the jacks 12 can bring the tractor trailer 16 to a stop when the driver falls asleep. The kill switch 42 may be in electrical communication with a pneumatic brake system of the semi tractor 33 for automatically engaging the pneumatic brake system when the kill switch 42 is disengaged.

A pump 46 is provided and the pump 46 is coupled to the semi tractor 33. The pump 46 is in fluid communication with a hydraulic system 48 of the semi tractor 33 such that the pump 46 receives hydraulic fluid from the hydraulic system 48. The pump 46 has an outlet 50 and the pump 46 is electrically coupled to the control circuit 32. The pump 46 urges the hydraulic fluid outwardly the outlet 50 when the control circuit 32 actuates any of the jacks 12 into the extended position. Conversely, the pump 46 urges the hydraulic fluid inwardly through the outlet 50 when the control actuates any of the jacks 12 into the retracted position. The pump 46 may be a hydraulic fluid pump of any conventional design. A hydraulic line 54 is fluidly coupled between the outlet 50 of the pump 46 and the input port 30 on the cylinder 24 of each of the jacks 12 thereby placing each of the jacks 12 in fluid communication with the pump 46. The pump 46 may have a left outlet and a right outlet for independently actuating the set of left jacks or the set of right jacks.

In use, the tractor trailer 16 is coupled to the semi tractor 33 and the hydraulic line 54 is attached to the output of the pump 46. Each of the left jacks 20 is actuated into the extended position when the semi tractor 33 tips beyond the predetermined degree of tilt. In this way the left jacks 20 inhibit the tractor trailer 16 from tipping over to the left. Each of the right jacks 22 is actuated into the extended position when the semi tractor 33 tips beyond the predetermined degree of tilt. In this way the right jacks 22 inhibit the tractor trailer 16 from tipping over to the right. Additionally, each of the left jacks 20 and the right jacks 22 are actuated into the deployed position when the semi tractor 33 exceeds the pre-determined trigger speed for slowing the semi tractor 33 and the tractor trailer 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tractor trailer jacking assembly being configured to inhibit a tractor trailer from tipping over, said assembly comprising:
a plurality of jacks, each of said jacks being mounted on a bottom of a tractor trailer, said plurality of jacks being distributed along a respective side of the tractor trailer, each of said jacks being positionable in an extended position wherein said jacks are configured to engage the ground to inhibit the tractor trailer from tipping, each of said jacks being positionable in a retracted position wherein said plurality of jacks is configured to facilitate the tractor trailer to be towed normally;
a control circuit being mounted on a semi tractor, said control circuit being in electrical communication with an ignition control system of the tractor trailer wherein said control circuit is configured to detect the speed of the tractor trailer, said control circuit being in electrical communication with each of said jacks, said control circuit actuating said jacks into said deployed position when said control circuit detects the speed of the tractor trailer has exceeded a pre-determined trigger speed wherein each of said jacks is configured to slow the semi tractor through friction with the ground; and
a gyroscope unit being mounted on the semi tractor wherein said gyroscope unit is configured to detect a degree and a direction to which the semi tractor is tipping, said gyroscope unit being in electrical communication with said control circuit, said control circuit actuating said respective jacks into said deployed position on a corresponding side of the tractor trailer when said gyroscope unit detects the semi tractor has tipped beyond a pre-determined angle of tilt wherein of said jacks is configured to inhibit the semi tractor from tipping over.

2. The assembly according to claim 1, wherein said plurality of jacks includes a set of left jacks and a set of right jacks, each of said left jacks being positioned on a left side of the tractor trailer, each of said right jacks being positioned on a right side of the tractor trailer.

3. The assembly according to claim 1, wherein each of said jacks includes a cylinder and a piston being slidably positioned in said cylinder, said piston having a distal end with respect to the bottom of the tractor trailer, said distal end engaging the ground when said jacks are in said extended position, said distal end being spaced from the ground when said jacks are in said retracted position, said cylinder having a input port thereon.

4. The assembly according to claim 2, wherein each of said left jacks is actuated when said gyroscope unit detects that the semi tractor is tipping to the left, each of said right jacks being actuated when said gyroscope unit detects that the semi tractor is tipping to the right.

5. The assembly according to claim 1, further comprising an override switch being positioned within said semi tractor wherein said override switch is configured to be accessible to the driver, said override switch being electrically coupled to said control circuit, said override switch inhibiting said control circuit from actuating said jacks in either said extended position or said retracted position when said override switch is engaged.

6. The assembly according to claim 1, further comprising a kill switch being attached to a steering wheel in the semi tractor wherein said kill switch is configured to be engaged when the driver grips the steering wheel, said kill switch being electrically coupled to said control circuit, said control circuit actuating each of said jacks into said deployed position when said kill switch is disengaged wherein said jacks are configured to bring the tractor trailer to a stop when the driver falls asleep.

7. The assembly according to claim 3, further comprising a pump being coupled to the semi tractor, said pump being in fluid communication with a hydraulic system of the semi tractor such that said pump receives hydraulic fluid from the hydraulic system, said pump having an outlet, said pump being electrically coupled to said control circuit, said pump urging the hydraulic fluid outwardly said outlet when said control circuit actuates any of said jacks into said extended position, said pump urging the hydraulic inwardly through the outlet when said control actuates any of said jacks into said retracted position.

8. The assembly according to claim 7, further comprising a hydraulic line being fluidly coupled between said outlet of said pump and said input port on said cylinder of each of said jacks thereby placing each of said jacks in fluid communication with said pump.

9. A tractor trailer jacking assembly being configured to inhibit a tractor trailer from tipping over, said assembly comprising:
a plurality of jacks, each of said jacks being mounted on a bottom of a tractor trailer, said plurality of jacks being distributed along a respective side of the tractor trailer, each of said jacks being positionable in an extended position wherein said jacks are configured to engage the ground to inhibit the tractor trailer from tipping, each of said jacks being positionable in a retracted position wherein said plurality of jacks is configured to facilitate the tractor trailer to be towed normally, said plurality of jacks including a set of left jacks and a set of right jacks, each of said left jacks being positioned on a left side of the tractor trailer, each of said right jacks being positioned on a right side of the tractor trailer, each of said jacks including a cylinder and a piston being slidably positioned in said cylinder, said piston having a distal end with respect to the bottom of the tractor trailer, said distal end engaging the ground when said jacks are in said extended position, said distal end being spaced from the ground when said jacks are in said retracted position, said cylinder having a input port thereon;
a control circuit being mounted on a semi tractor, said control circuit being in electrical communication with an ignition control system of the tractor trailer wherein said control circuit is configured to detect the speed of the tractor trailer, said control circuit being in electrical communication with each of said jacks, said control circuit actuating said jacks into said deployed position when said control circuit detects the speed of the tractor trailer has exceeded a pre-determined trigger speed wherein each of said jacks is configured to slow the semi tractor through friction with the ground;
a gyroscope unit being mounted on the semi tractor wherein said gyroscope unit is configured to detect a degree and a direction to which the semi tractor is tipping, said gyroscope unit being in electrical communication with said control circuit, said control circuit actuating said respective jacks into said deployed position on a corresponding side of the tractor trailer when said gyroscope unit detects the semi tractor has tipped beyond a pre-determined angle of tilt wherein of said jacks is configured to inhibit the semi tractor from tipping over, each of said left jacks being actuated when said gyroscope unit detects that the semi tractor is tipping to the left, each of said right jacks being actuated when said gyroscope unit detects that the semi tractor is tipping to the right;
an override switch being positioned within said semi tractor wherein said override switch is configured to be accessible to the driver, said override switch being electrically coupled to said control circuit, said override switch inhibiting said control circuit from actuating said jacks in either said extended position or said retracted position when said override switch is engaged;
a kill switch being attached to a steering wheel in the semi tractor wherein said kill switch is configured to be engaged when the driver grips the steering wheel, said kill switch being electrically coupled to said control circuit, said control circuit actuating each of said jacks into said deployed position when said kill switch is disengaged wherein said jacks are configured to bring the tractor trailer to a stop when the driver falls asleep;
a pump being coupled to the semi tractor, said pump being in fluid communication with a hydraulic system of the semi tractor such that said pump receives hydraulic fluid from the hydraulic system, said pump having an outlet, said pump being electrically coupled to said control circuit, said pump urging the hydraulic fluid outwardly said outlet when said control circuit actuates any of said jacks into said extended position, said pump urging the hydraulic inwardly through the outlet when said control actuates any of said jacks into said retracted position; and
a hydraulic line being fluidly coupled between said outlet of said pump and said input port on said cylinder of each of said jacks thereby placing each of said jacks in fluid communication with said pump.

10. A tractor trailer jacking system being configured to inhibit a tractor trailer from tipping over, said system comprising:
a tractor trailer having a left side and a right side;
a semi tractor having said tractor trailer being attached thereto for towing;
a plurality of jacks, each of said jacks being mounted on a bottom of said tractor trailer, said plurality of jacks being distributed along a respective side of the tractor trailer, each of said jacks being positionable in an extended position to engage the ground thereby inhibiting said tractor trailer from tipping, each of said jacks being positionable in a retracted position facilitate said tractor trailer to be towed normally, said plurality of jacks including a set of left jacks and a set of right jacks, each of said left jacks being positioned on said left side of said tractor trailer, each of said right jacks being positioned on said right side of said tractor trailer, each of said jacks including a cylinder and a piston being slidably positioned in said cylinder, said piston having a distal end with respect to the bottom of the tractor trailer, said distal end engaging the ground when said jacks are in said extended position, said distal end being spaced from the ground when said jacks are in said retracted position, said cylinder having a input port thereon;
a control circuit being mounted on said semi tractor, said control circuit being in electrical communication with an ignition control system of said semi tractor wherein said control circuit is configured to detect the speed of the tractor trailer, said control circuit being in electrical communication with each of said jacks, said control circuit actuating said jacks into said deployed position when said control circuit detects the speed of said tractor trailer has exceeded a pre-determined trigger speed to slow said semi tractor through friction with the ground;
a gyroscope unit being mounted on the semi tractor to detect a degree and a direction to which said semi tractor is tipping, said gyroscope unit being in electrical communication with said control circuit, said control circuit actuating said respective jacks into said deployed position on a corresponding side of said tractor trailer when said gyroscope unit detects said semi tractor has tipped beyond a pre-determined angle of tilt wherein of said jacks is configured to inhibit said semi tractor and said tractor trailer from tipping over, each of said left jacks being actuated when said gyroscope unit detects that said semi tractor is tipping to the left, each of said right jacks being actuated when said gyroscope unit detects that said semi tractor is tipping to the right;
an override switch being positioned within said semi tractor wherein said override switch is configured to be accessible to the driver, said override switch being electrically coupled to said control circuit, said override switch inhibiting said control circuit from actuating said jacks in either said extended position or said retracted position when said override switch is engaged;
a kill switch being attached to a steering wheel in said semi tractor wherein said kill switch is configured to be engaged when the driver grips the steering wheel, said kill switch being electrically coupled to said control circuit, said control circuit actuating each of said jacks into said deployed position when said kill switch is disengaged thereby facilitating said jacks to bring said tractor trailer to a stop when the driver falls asleep;
a pump being coupled to said semi tractor, said pump being in fluid communication with a hydraulic system of said semi tractor such that said pump receives hydraulic fluid from said hydraulic system, said pump having an outlet, said pump being electrically coupled to said control circuit, said pump urging the hydraulic fluid outwardly said outlet when said control circuit actuates any of said jacks into said extended position, said pump urging the hydraulic inwardly through the outlet when said control actuates any of said jacks into said retracted position; and
a hydraulic line being fluidly coupled between said outlet of said pump and said input port on said cylinder of each of said jacks thereby placing each of said jacks in fluid communication with said pump.
